(19) United States
(12) Patent Application Publication
(10) Pub. No.: US 2019/0044744 A1
(43) Pub. Date: Feb. 7, 2019

(54) DOWNLOADABLE APPLICATION FOR COMPETITIVE POLICY DEBATE

(71) Applicant: Nikhil Yagnik, Alpharetta, GA (US)

(72) Inventor: Nikhil Yagnik, Alpharetta, GA (US)

(21) Appl. No.: 15/667,164

(22) Filed: Aug. 2, 2017

(51) Int. Cl. H04L 12/18; G06Q 50/00; H04L 29/06; H04L 12/58; G09B 19/04; G09B 5/06; G09B 7/02

(52) U.S. Cl. CPC H04L 12/1818; G06Q 50/01; H04L 63/10; G09B 7/02; H04L 12/1822; G09B 19/04; G09B 5/065; H04L 51/32

(57) ABSTRACT

Certain exemplary method and/or system embodiments provide mobile application that combines social media and debate instruction. Exemplary application embodiments teach middle school students, high school students, and college students the basics of competitive policy debate. Exemplary application embodiments will also have a section that aids students with the current year's policy resolution. Exemplary method and/or apparatus embodiments of an Online Forum provide another dimension to the learning experience; it allows debaters to collaborate via an online communication platform that leverages their social media accounts with appropriate levels of security. The host and facilitator of the online forum will be a persona called iNik.

### FIELD OF THE INVENTION

This invention relates to the fields of education, mobile applications, and social media. It is more specifically related to apparatus and/or methods to provide an app to teach competitive debate and provide a platform for collaboration among debaters.

### BACKGROUND OF THE INVENTION

Thousands of middle school, high school and university or college students participate in competitive policy debate.

The goal in policy debate is to influence the judge through sound argumentation.

There are 2 sides of the argument. The affirmative, or aff, and the negative, or neg. The aff team generally advocates a plan in the first speech of the debate that supports a specific action that falls under the resolution. A possible plan text could be: The United States federal government should substantially increase its funding of science, technology, engineering, and mathematics programs in its public schools.

The neg's job is simple. Find a reason for the judge not to vote aff or affirm the plan. The neg has a variety of ways to do this. They could find disadvantages to doing the plan (your idea is bad because it will cause X). They could come up with another idea that accomplishes the goals of the plan without causing a disadvantage. This alternate idea is called a counterplan. The neg could also criticize the aff from a philosophical or ideological perspective. This is called a Kritik. The next neg strategy is too accuse the aff of cheating. If the aff reads a plan that doesn't adhere to the resolution, doesn't even read a plan, or does something else that the neg deems abusive, then the neg could read an argument claiming the aff cheated and should be disqualified. These arguments fall under the broad category of theory. Theory arguments must be won by proving that the other team's actions have hurt fairness and education in debate. The most common negative theory argument is topicality. This is when the negative charges that the aff plan or advocacy, does not fall within the scope of the resolution, which is unfair and un-educational. Because of this, the judge should vote neg.

Unfortunately, there is a lack of access to debate education, and there is no mobile platform for collaboration. The application aims to teach students policy debate, allow them to practice with provided drills, and create a platform for debaters to collaborate via social media.

### SUMMARY OF THE INVENTION

Another object of this application is to address, in whole or in part, at least the foregoing and other deficiencies in the related art.

It is another object of this application to provide, in whole or in part, at least the advantages described herein.

Certain exemplary method and/or system embodiments provide mobile application that combines social media and debate instruction. The Debate Coach is the first ever mobile application that combines social media and debate instruction. Exemplary application embodiments teaches middle school students, high school students, and college students the basics of competitive policy debate. Exemplary application embodiments will also have a section that aids students with the current year's policy resolution. The section will be updated to provide students the tools and perspective for them to form a position on the resolution. A specific feature will include specially formatted evidence called “cards”. Cards are tools debaters leverage to form and develop their positions. These cards will be updated annually to reflect the academic year's resolution established by the debate community.

Exemplary method and/or apparatus embodiments of The Debate Coach's Online Forum provide another dimension to the learning experience; it allows debaters to collaborate via an online communication platform that leverages their social media accounts. The host and facilitator of the online forum will be a persona called iNik. iNik will cultivate the brand for the Debate Coach and provide unique guidance to the debaters.

These objects are given only by way of illustrative example, and such objects may be exemplary of one or more embodiments of the invention. Other desirable objectives and advantages inherently achieved by the may occur or become apparent to those skilled in the art. The invention is defined by the appended claims.

### BRIEF DESCRIPTION OF FIGURES

The foregoing and other objects, features, and advantages of the invention will be apparent from the following more particular description of the embodiments of the invention, as illustrated in the accompanying drawings. The elements of the drawings are not necessarily to scale relative to each other.

FIG. 1 is a diagram that shows an exemplary home screen and the options the user has. It reflects the categories and organization of content.

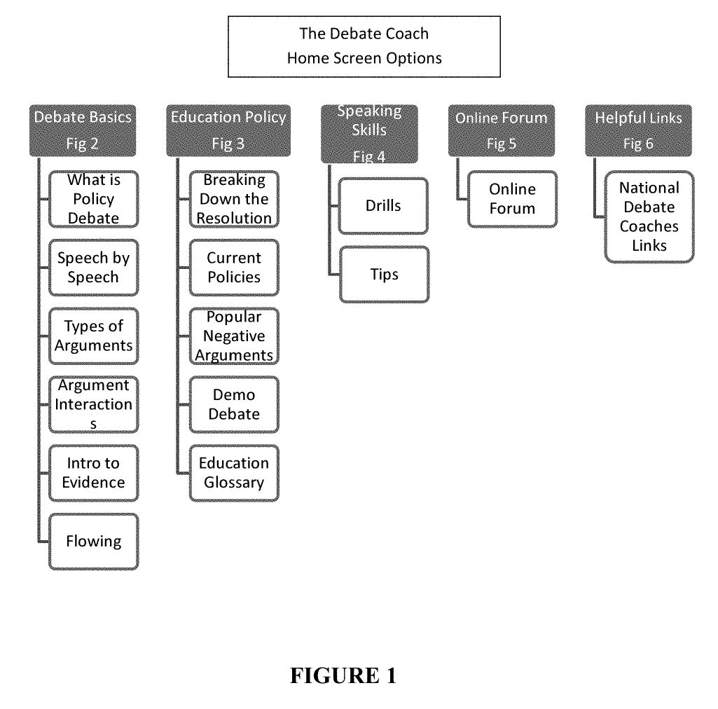

FIG. 2 is a diagram that shows an exemplary Debate Basics category and the options the user has to further explore this content.

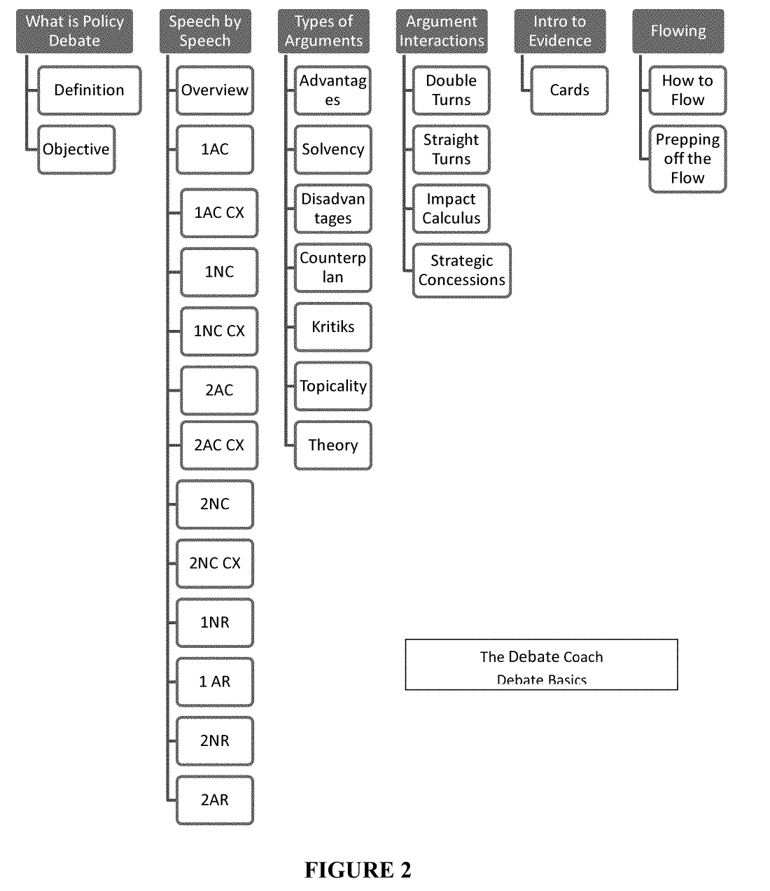

FIG. 3 is a diagram that shows an exemplary National Resolution for the academic year. The user can explore both the resolution and sample evidence provided by the Emory National Debate Institute.

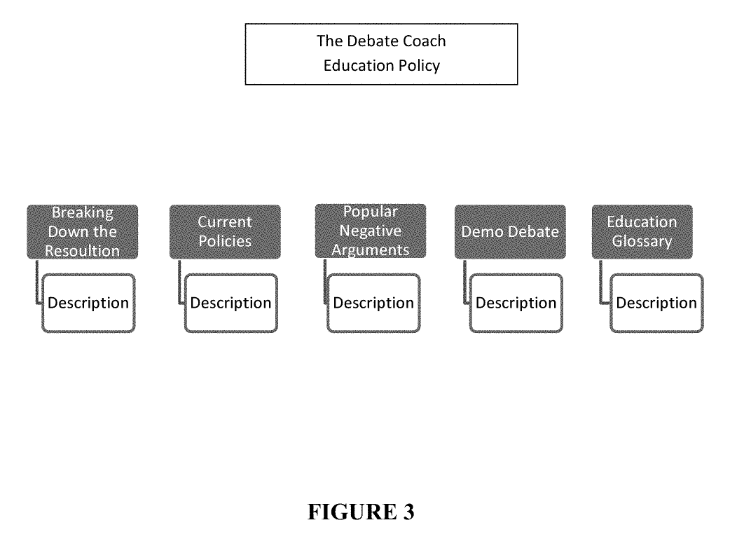

FIG. 4 is a diagram that shows an exemplary debate drills and tips to help students with their oratory skills needed in Policy Debate.

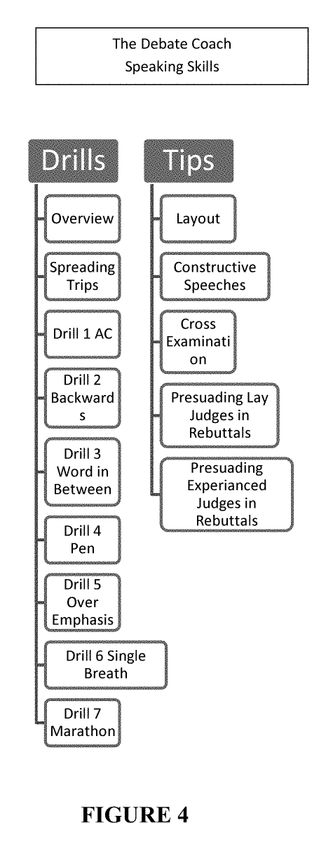

FIG. 5 is a diagram that shows an exemplary online debate community access functionality. Users can post questions, comments or replies using their Facebook or Twitter personas.

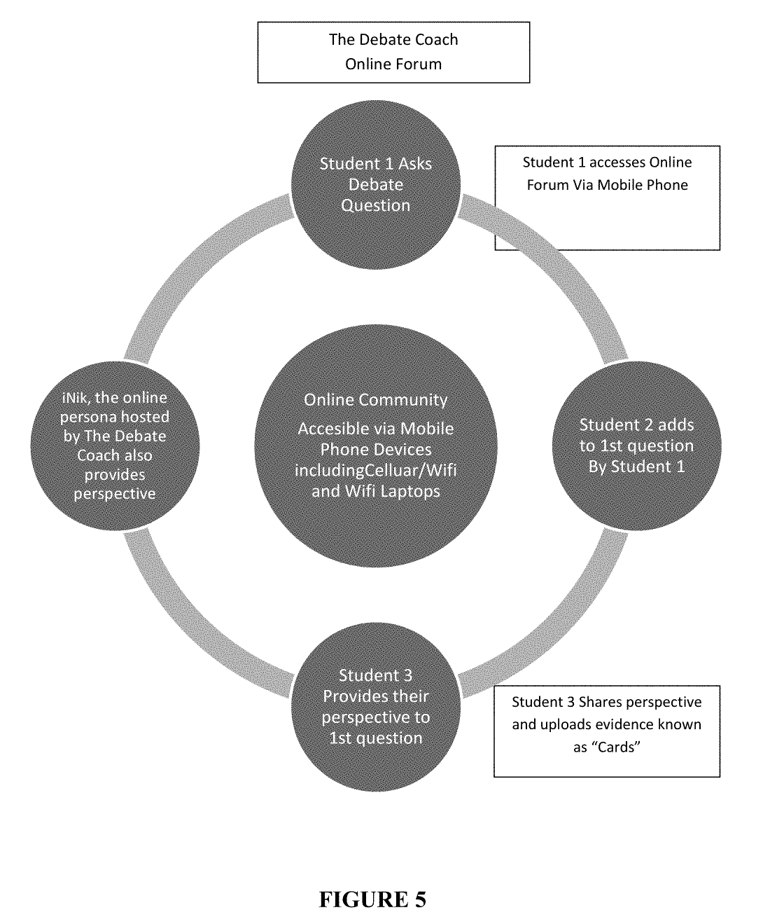

FIG. 6 is a diagram that shows an exemplary functionality providing the user with links that further explore Policy Debate.

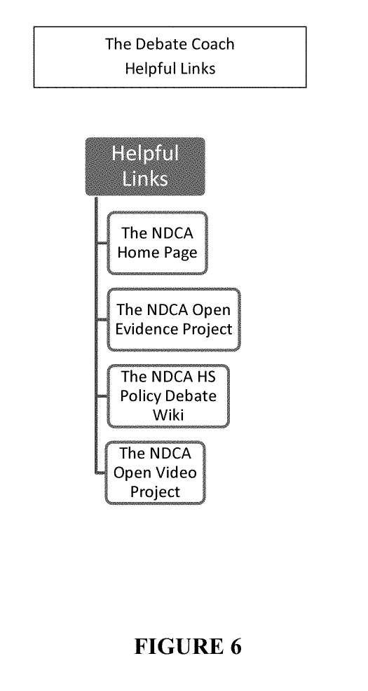

FIG. 7 is a diagram that shows an exemplary system embodiment for hosting an on-line application for filtering and evaluating information regarding debates in accordance with the application.

### DESCRIPTION OF EXEMPLARY EMBODIMENTS

Exemplary embodiments of the application provide a method, process, and computer program product for real-time web-based debate platform allowing generalized synchronized exchanges of individual points-of-view on a user-identified topic. The following description is presented to enable one of ordinary skill in the art to make and use the invention and is provided in the context of a patent application and its requirements.

Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

As noted herein, the system and process are most preferably implemented in a system and method, including computer-implemented methods having a processor executing computer program instructions from a memory to effect the real-time debate between multiple users of topics of interest to them personally. The app includes a consolidated policy debate tutorial in the “Debate Basics” category. This section explains what debate is and gives unique strategic guidance to students about specific speeches, argument types, and the mechanics of debate. By downloading this app, students can access debate advice offline on their mobile phones for the first time. Exemplary parts of the debate basics category are below.
i. In the “What is Policy Debate” section, there is a definition of policy debate and an explanation of the objective of policy debate. The definition includes an introduction to the annual resolution/topic of debate. The explanation of the objective introduces students to the teams in debate and the types of arguments that are most common.
ii. The “speech by speech” section introduces students to the speeches and cross examinations in policy debate. The speech by speech section contains an overview of the sequence of speeches as well as in depth explanations (some with examples) of each speech in a policy debate round. There are explanations for the 1AC, 1AC cross examination, 1NC, 1NC cross examination, 2AC, 2AC cross examination, 2NC, 2NC cross examination, 1NR, 1AR, 2NR, and 2AR.
iii. The “Types of Arguments” section details the different categories if arguments that a debater may encounter. For each type of argument-advantage, solvency, disadvantage, counterplan, kritik, topicality, and theory-there is an explanation of what the argument is, how each argument is structured, how to answer the argument, and an example of each.
iv. The “argument interactions” section gives more advanced advice on how to debate strategically. The section focuses on how groups of arguments affect the big picture of a debate. The section explains how to avoid double turns (contradicting yourself), answer straight turns (defend yourself), do impact calculus (explain why your argument matters more than your opponent's), and make strategic concessions (giving up on losing arguments).
v. The “Intro to evidence” section explains what cards (excerpts from research sources) are. The section's card explanation explains how to format debate evidence and gives an example of a formatted debate card.
vi. The “Flowing” section explains how to take notes on speeches during a debate. The section explains how to flow and provides an example. The section also explains how to prepare speeches using your notes/flows and provides an example.

In “Education Policy”, the app includes an introduction to the year's topic for policy debate. This year, middle and high school policy debaters will be debating US federal education policy. The app includes examples of possible arguments, an overview of the topic/resolution, an explanation of a few current education policies, a link to a demo debate, and a short glossary of key terms. The parts of the education policy category are listed below.
i. The “Breaking Down the Resolution” section explains the significance of each word in the resolution, “Resolved: The United States federal government should substantially increase its funding and/or regulation of elementary and/or secondary education in the United States.” This helps debaters understand what the resolution means and what topics will be included during the debate season.
ii. The “Current Policies” section introduces students to a few education laws and programs to increase their understanding of education policy. The section also includes links to websites that help explain federal education-related programs.
iii. The “Popular negative arguments” section gives an overview of a few arguments that will probably be popular among debaters. The section details what the arguments are and includes examples of the arguments and some responses.
iv. The “Demo debate” section provides a link to a video showing an example debate. Debaters are able to watch and learn from this example debate.
v. The education glossary defines a few key terms related to education policy and provides definitions for each word in the debate resolution. This section helps students understand the topic.

The “speaking skills” category consists of two parts: drills and tips. The drills section contains multiple methods debaters can use to improve their reading speed and clarity in speeches. The tips section contains suggestions for how debaters should speak, look, and act in various parts of a policy debate round. The tips also contain suggestions on how to persuade different kinds of judges in a debate round. The parts of the speaking skills category are listed below.
i. The “drills” section contains a few tips on how to speak and practice but mainly consists of drills to increase speed and clarity. Each drill contains information on how long to do the drill, how to do the drill, and why to do the drill. The drills make the app more interactive
ii. The “tips” section contains suggestions on how to ask questions, answer questions, give opening (constructive) speeches, and give closing (rebuttal) speeches. There are also tips on how to persuade different types of judges

The “online forum” is a fan wall that leverages Facebook and Twitter to create a platform for debaters to collaborate and exchange ideas. Any user may post to the online forum, and all users can see and respond to these posts. The online form will facilitate the creation of an online debate community. Certain exemplary method and/or system embodiments can implement a security structure (or privacy) based on user class, where middle school students are not allowed to provide any detailed or personal data (e.g., online location, etc.), high school students have selectable personal data based on age, and college students default to providing all detailed or personal data with opt out procedures. Such security provisions allow the Debate Coach to implement across middle school, high school and college level competitive policy debates.

The “Helpful Links” category contains links to websites run by the National Debate Coaches Association. The links make The Debate Coach a consolidated, comprehensive debate resource.

Another unique aspect of this first Mobile Phone Application for Policy debate is the ability to access content and the online community via Mobile Cellular access. Today, most students must use their laptops to access content and communities and are constrained by the availability of wifi networks. This Mobile App frees the user to access the debate community and content via their cellular mobile phones.

The online forum will allow users to share more than ideas, it will allow them to share content such as research known as “Cards” and evidence in the debate community.

The exemplary embodiments of the application can provide an environment with communications system including communications technology an Internet technology-based infrastructure and processes, cellular, satellite, local/wide area network, etc.) that enable server computer(s) to create, access, manipulate, and exchange information, particularly with clients (e.g., client computer) for supporting interactive exemplary Debate Coach embodiments among a community of interested and informed individuals with the goal of helping individuals filter and evaluate conflicting information, claims, arguments and evidence regarding complex issues of fact, policy or belief, in particular regarding a current year resolution. As noted earlier, the presently preferred implementation includes a database, a Debate Coach process, Community Services, mechanisms for site organization and operation, and user interfaces. These elements are shown schematically in the appended drawings. After discussing the technical architecture. implementation, we explore the implementation of each of these elements in more detail. We conclude with a review of some of the deployment options for the preferred implementation.

### (a) Technical Architecture

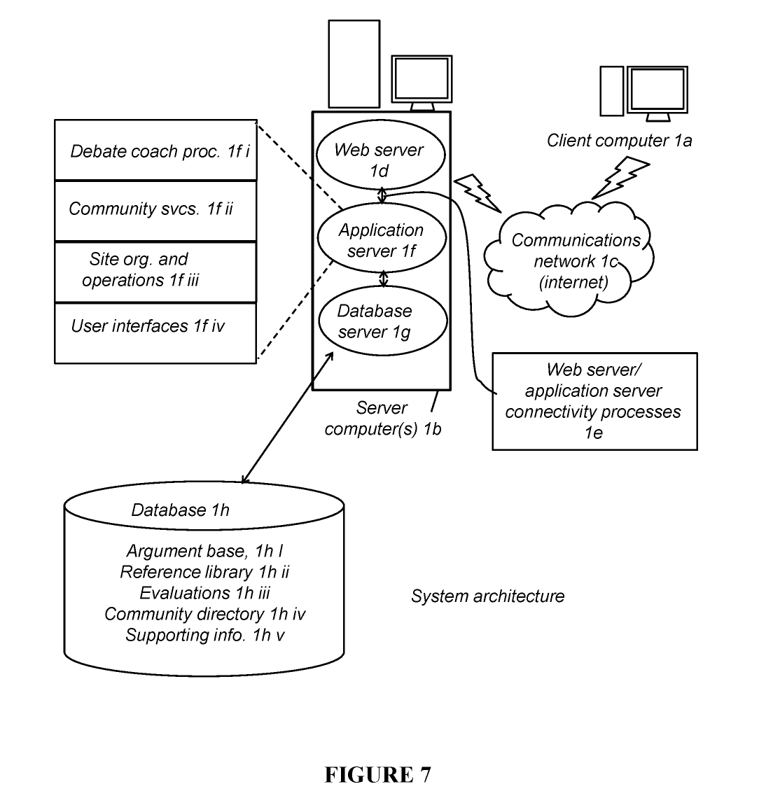

The technical architecture of the presently preferred implementation includes the following elements (see FIG. 7):

A standard Web browser (element 1 a) such as Netscape Communicator or Microsoft Internet Explorer running on a user's computer and supporting client-side scripting such as JavaScript or VBScript.

One or more server computers (element 1 b) running one or inure instances of the server processes.

A communications network connecting the client computer(s) to the server computer(s) (element 1 c). In the preferred implementation, the network supports the Internet protocols TCP/IP and HTTP.

A standard Web server (element 1 d) such as Microsoft Internet Information Server supporting connectivity to the application server processes through Microsoft Active Server Pages (ASP) and ActiveX Server controls. The Web-server/application server connectivity processes (element 1 e) render the user interface into HTML plus client side JavaScript for transmission to the user's Web browser. They also translate the user's commands and information into a format understandable by the application server processes for processing. Application server processes (element 1 f) that perform the processing tasks of the application, including the Rating Process, Community Services, Site Organization and Operation, and the User Interface. These processes are discussed in more detail in subsequent sections. Database Management System (DBMS) (element 1 g), such as Oracle and SQL Server, are server processes that connect the application server processes to the application database (element 1 h).

The invention is by no means limited to this architecture. Alternatives include (but are not limited to):

In the preferred implementation, the user interface (UI) is implemented through HTML rendered by the server with minimal client processing through client side JavaScript. More processing could be distributed to the client computer through the use of Java applets, ActiveX controls, or other distributed computing technology. Alternatively, a pure HTML interface could be implemented with no client-side scripting.

In the preferred implementation, the communications network is the Internet. Alternatively, the invention could be implemented on an intranet, extranet, LAN, or WAN. In the preferred implementation, the client and network communications are based on widely accepted Internet standards (TCP/IP, HTTP, HTML, JavaScript, etc.). Alternatively, the invention could be implemented with a proprietary client process or with other network and distributed processing protocols, such as Netware, DCom, or CORBA.

In the preferred implementation, interaction between the application and the Web servers is implemented through Microsoft Active Server Pages with ActiveX Server Controls. This interaction could be implemented with lower level Application Programming Interfaces (API) or through Java Server Applets. Alternatively, Web server functionality could be built directly into the application server.

Clients (e.g., client computers 1a) can be implemented using electronic computing devices, each having an interface, a processor, and a memory for storing instructions and data. These devices include portable electronic devices and other user computing systems for receiving and displaying content from server (e.g., server 1b) as well as composing and sending user contributions to server. The content from server may be in any format that may be rendered to user-perceptible format by clients, including text, audio, video, and the like. The interface also includes one or more mechanisms for the user to contribute content, including typing, speaking, writing, and other interface modalities appropriate to client. In some cases, depending upon context, client is referring to an electronic device supporting the functions, and sometimes client is referring to the aggregation of functional elements divorced from the electronic device. Some of this distinction arises because client may be implemented as a specialized device or it may be implemented as an application or suite of applications on the electronic devices through an operating environment, in which case the client is one of several potential processes on the device.

Client communications (e.g., communication network 115 and/or data communications system) each represent the communications technology that enable server to create, access, manipulate, and exchange information, particularly with clients (client computer 1a) and/or data. sources, respectively. The communications systems are a combination of information technology and communications technology appropriate for the type of content and devices server interfaces to when implementing its functions as described herein. It provides, as necessary or desired, technologies for collaboration, messaging, calendaring, instant messaging, media, text, audio, video, and conferencing, implemented using appropriate technologies including intranet, internet (e.g., the Internet), web, wireless, wired, telephonic, cloud computing, WAN, LAN, and other modalities for exchanging content. Client communications can be distinct from data communications system to illustrate that server (sever computer 1b) may not use the same communications technology for exchanging content with clients as it does with data sources. However, they may both use the same communications technology as well.

The implementation may also include middleware, such as Microsoft Transaction Server or Tuxedo transaction processor.

The implementation may employ new tools, standards, and protocols as they develop.

### (b) Database

The application database (element 1 h) stores the information used by and manipulated by the application server process. The key areas of information stored in the application database include:

The Argument Base (element 1 h(i))—Debate and discussion stored as a network of propositions linked by logical relationships.

The Reference Library (element 1 h(ii))—Information on sources outside of the debate that are inform the debate and are linked to specific statements and assertions in the argument base.

Evaluations (element 1 h(iii))—Individual users' judgements about elements in the argument base and reference library and other objects in the system (including other users). These judgements include numerical ratings that are used by the rating process to filter the information in the system.

Community Directory (element 1 h(iv))—Information on members and contributors, including their profiles and credentials.

Other Supporting Information (element 1 h(v))—Additional information to support the organization and operation of the system.

Certain exemplary method and/or system embodiments can be implemented using available software applications that provide structure (e.g., hardware, software and user access to provide Application Builder functionality for individuals, for Small Business or for large corporations. Such available software applications allow small businesses, etc. to create their own app or become a reseller and build apps for others. One exemplary platform provider is BiznessAPPS (at web site address having top-level .com domain name “biznessapps”).

The system, method, and computer-program product above has been described in the preferred embodiment including a suitably programmed general purpose computer, real, virtual, and/or cloud-based, including a processing unit executing instructions read from a memory, controlled using one more user interfaces, with the memory being local or remote to the system, and in some cases a wired/wireless interconnection with other computing systems for the access/sharing/aggregation of data. In some embodiments, the devices communicate via a peer-to-peer communications system in addition to or in lieu of Server/Client communications.

The system, method, and computer program product, described in this application may, of course, be embodied in hardware; e.g., within or coupled to a Central Processing Unit (“CPU”), microprocessor, microcontroller. System on Chip (“SOC”), or any other programmable device. Additionally, the system, method, computer program product, and propagated signal may be embodied in software (e.g., computer readable code, program code, instructions and/or data disposed in any form, such as source, object or machine language) disposed, for example, in a computer usable (e.g., readable) medium configured to store the software. Such software enables the function, fabrication, modeling, simulation, description and/or testing of the apparatus and processes described herein. For example, this can be accomplished through the use of general programming languages (e.g., C, C++), GDSII databases, hardware description languages (HDL) including Verilog HDL, VHDL, AHDL (Altera HDL) and so on, or other available programs, databases, nanoprocessing, and/or circuit (i.e., schematic) capture tools. Such software can be disposed in any known computer usable medium including semiconductor, magnetic disk, optical disc (e.g., CD-ROM, DVD-ROM, etc.) and as a computer data signal embodied in a computer usable (e.g., readable) transmission medium (e.g., carrier wave or any other medium including digital, optical, or analog-based medium). As such, the software can be transmitted over communication networks including the Internet and intranets. A system, method, and computer program product embodied in software may be included in a semiconductor intellectual property core (e.g., embodied in HDL) and transformed to hardware in the production of integrated circuits. Additionally, a system, method, and computer program product as described herein may be embodied as a combination of hardware and software.

One of the preferred implementations of the application is as a routine in an operating system made up of programming steps or instructions resident in a memory of a computing system as well known, during computer operations. Until required by the computer system, the program instructions may be stored in another readable medium, e.g. in a disk drive, or in a removable memory, such as an optical disk for use in a CD ROM computer input or in a floppy disk for use in a floppy disk drive computer input. Further, the program instructions may be stored in the memory of another computer prior to use in the system of the application and transmitted over a LAN or a WAN, such as the Internet, when required by the user of the application. One skilled in the art should appreciate that the processes controlling the application are capable of being distributed in the form of computer readable media in a variety of forms.

Any suitable programming language can be used to implement the routines of the application including C, C++, Java, assembly language, and the like. Different programming techniques can be employed such as procedural or object oriented. The routines can execute on a single processing device or multiple processors. Although the steps, operations or computations may be presented in a specific order, this order may be changed in different embodiments. In some embodiments, multiple steps shown as sequential in this specification can be performed at the same time. The sequence of operations described herein can be interrupted, suspended, or otherwise controlled by another process, such as an operating system, kernel, and the like. The routines can operate in an operating system environment or as stand-alone routines occupying all, or a substantial part, of the system processing.

In the description herein, numerous specific details are provided, such as examples of components and/or methods, to provide a thorough understanding of embodiments of the application. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the application.

A “computer-readable medium” for purposes of embodiments of the application may be any medium that can contain, store, communicate, transmit, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” and the like. Portions of processing can be performed at different times and at different locations, by different (or the same) processing systems.

Reference throughout this specification to “one embodiment”, “an embodiment”, or “a specific embodiment” means that a particular feature, structure, or characteristic described in connection with the embodiment is included in at least one embodiment of the application and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the application may be combined in any suitable manner with one or more other embodiments. It is to be understood that other variations and modifications of the embodiments of the application described and illustrated herein are possible in light of the teachings herein and are to be considered as part of the spirit and scope of the application.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of the application can be achieved by any means as is known in the art. Distributed, or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the application to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the application, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the application, as those skilled in the relevant art will recognize and appreciate. As indicated, these modifications may be made to the application in light of the foregoing description of illustrated embodiments of the application and are to be included within the spirit and scope of the application.

Thus, while the application has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the application. It is intended that the invention not be limited to the particular terms used in following claims and/or to the particular embodiment disclosed as the best mode contemplated for carrying out this invention, but that the invention will include any and all embodiments and equivalents falling within the scope of the appended claims. Thus, the scope of the invention is to be determined solely by the appended claims.

What is claimed is:

1. A network-based system for online debate, comprising:
(a) a server computer operatively coupled to a network and accessible to a plurality of users via client computers coupled to the network;
(b) a database operatively coupled to the server, the database including an argument base; and
(c) a software process, supported by the server, for supporting the on-line debate process;
wherein the software process provides the users access to a plurality of user screens including a debate basics category, an education policy category, speaking skills category and an online forum category,
where the online forum includes a fan wall that leverages Facebook and Twitter to create a platform for debaters to collaborate and exchange ideas, where any user post to the online forum is viewable and respondable by all users, to form an online debate community.

2. The network-based system for online debate of claim 1, where the debate basics category includes at least three or more of a what is policy debate section, a speech by speech section, a types of arguments section, an argument interactions section, an intro to evidence section and a flowing section.

3. The network-based system for online debate of claim 1, where the education policy category includes at least three or more of a breaking down the resolution” section, a current policies section, a popular negative arguments section, and a demo debate section.

4. The network-based system for online debate of claim 1, where the speaking skills category includes drills and tips sections, where the drills section includes multiple methods debaters can use to improve their reading speed and clarity in speeches, and where the tips section includes how debaters should speak, look, and act in various parts of a policy debate round and how to persuade different kinds of judges in a debate round.

5. The network-based system for online debate of claim 1, where the online forum implements security to reduce access to middle school participants, provide user selectable access to high school students over a prescribed age, and provides opt out only security to college participants.

6. A computer-implemented method for providing a real-time web-based policy debate-platform in an environment managed by a computing system, the method comprising:
(a) hosting a service-manager supporting a website-interface for the web-based debate-forum, where the website-interface includes a debate basics category, an education policy category, speaking skills category and an online forum category, wherein a plurality of users each open an account, access said account, create a profile, post an entry which is displayed on said website-interface, and view on said website-interface one or more entries posted by said plurality of users;
(b) starting a plurality of concurrent debate sessions on at least one debate-topic that includes for each debate session: opening a debate on the debate-forum, creating a debate profile, posting a description of said debate-topic, and posting one or more entries associated with said debate-topic;
(c) registering in the debate-forum one or more other users as members of a group of debate-participants;
(d) posting by said debate-participants entries in the online forum containing feedback, ideas, answers, and comments to said debate-topic and to entries posted by said group of debate-participants; and
(e) sequentially posting said entries on said website-interface to develop a stream of entries for the real-time web-based debate-forum.

7. The method of claim 6, where the debate basics category includes at least three or more of a what is policy debate section, a speech by speech section, a types of arguments section, an argument interactions section, an intro to evidence section and a flowing section.

8. The method of claim 6, where the education policy category includes at least three or more of a breaking down the resolution section, a current policies section, a popular negative arguments section, and a demo debate section.

9. The method of claim 6, where the speaking skills category includes drills and tips sections, where the drills section includes multiple methods debaters can use to improve their reading speed and clarity in speeches, and where the tips section includes how debaters should speak, look, and act in various parts of a policy debate round and how to persuade different kinds of judges in a debate round.

10. The method of claim 6, where the online forum includes a fan wall that leverages social media to create a platform for debaters to collaborate and exchange ideas, where any user post to the online forum is viewable and respondable by all users, to form an online debate community, where the online forum implements security to reduce access to middle school participants, provide user selectable access to high school students over a prescribed age, and provides opt out only security to college participants.
